(19) United States
(12) Patent Application Publication
(10) Pub. No.: US 2026/0253597 A1
(43) Pub. Date: Aug. 27, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Kenkoh ENDOH, Tokyo (JP); Hitoshi YAMAMOTO, Tokyo (JP); Hong YANG, Tokyo (JP)

(73) Assignee: NEC Corporation, Tokyo (JP)

(21) Appl. No.: 19/163,455

(22) PCT Filed: Jan. 16, 2024
(86) PCT No.: PCT/JP2024/000990

§ 371 Date: Sep. 9, 2025

(30) Foreign Application Priority Data
Mar. 13, 2023 (JP) 2023-039058

(51) Int. Cl. G10L 21/0216; G10L 25/27

(52) U.S. Cl. CPC G10L 21/0216; G10L 25/27

(57) ABSTRACT

An information processing apparatus including: a constraint loss calculation unit that calculates a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and a parameter update unit that updates parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

### TECHNICAL FIELD

This disclosure relates to the technical field of information processing apparatus, information processing methods, and recording media.

### BACKGROUND ART

Non-patent literature 1 describes a technology for estimating a speech enhancement mask and a noise enhancement mask using a model, calculating an index using the estimated masks, and training the model using the deviation between the calculated index and the ideal value of the index.

### CITATION LIST

### Non-Patent Literature

Non-patent Literature 1: Investigations on Data Augmentation and Loss Functions for Deep Learning Based Speech-Background Separation; Interspeech 2018; P. 3499-3503

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: a constraint loss calculation unit that calculates a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and a parameter update unit that updates parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

An information processing method according to an example aspect includes calculating a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and updating parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

A recording medium according to an example aspect is a recording medium on which a computer program that allows a computer to execute an information processing method is recorded, the information processing method including calculating a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and updating parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

### BRIEF DESCRIPTION OF DRAWINGS

FIG. 1 is a block diagram illustrating a configuration of an information processing apparatus according to this disclosure.

FIG. 2 is a block diagram illustrating a configuration of an information processing apparatus according to this disclosure.

FIG. 3 is a flowchart illustrating a flow of an information processing operation of an information processing apparatus according to this disclosure.

FIG. 4 is a block diagram illustrating a configuration of an information processing apparatus according to this disclosure.

FIG. 5 is a block diagram illustrating a configuration of an information processing apparatus according to this disclosure.

FIG. 6 is a block diagram illustrating a configuration of an information processing apparatus according to this disclosure.

FIG. 7 is a flowchart illustrating a flow of an information processing operation of an information processing apparatus according to this disclosure.

FIG. 8 is a block diagram illustrating a configuration of an information processing apparatus according to this disclosure.

FIG. 9 is a flowchart illustrating a flow of an information processing operation of an information processing apparatus according to this disclosure.

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### 1-1: Configuration of the Information Processing Apparatus 1

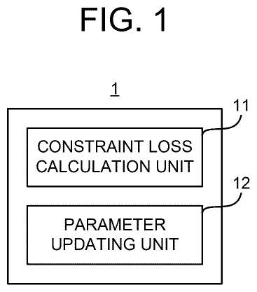

FIG. 1 is a block diagram showing the configuration of the information processing apparatus 1 according to the first embodiment. As shown in FIG. 1, the information processing apparatus 1 includes a constraint loss calculation unit 11 and a parameter update unit 12.

The constraint loss calculation unit 11 calculates a constraint loss using an estimated speech enhancement mask output from a speech enhancement mask estimation model to which noise-mixed speech is input, and an estimated noise enhancement mask output from a noise enhancement mask estimation model to which noise-mixed speech is input. The parameter update unit 12 updates parameters included in the speech enhancement mask estimation model and parameters included in the noise enhancement mask estimation model using a speech enhancement mask loss indicating a difference between the estimated speech enhancement mask and a target speech enhancement mask, a speech enhancement mask loss indicating a difference between the estimated noise enhancement mask and a target noise enhancement mask, and the constraint loss. Note that “the noise-mixed speech,” “the speech enhancement mask estimation model,” “the estimated speech enhancement mask,” “the noise enhancement mask estimation model,” “the estimated noise enhancement mask,” “the constraint loss,” “the target speech enhancement mask,” “the speech enhancement mask loss,” “the target noise enhancement mask,” and “the noise enhancement mask loss” will be explained in detail in other embodiments described later.

### 1-2: Technical Effects of the Information Processing Apparatus 1

The information processing apparatus 1 according to the first embodiment introduces the constraint loss calculated using the estimated speech enhancement mask output by the speech enhancement mask estimation model that relatively reduces volume of time and frequency bands of noise other than the target speech included in the input speech, and the estimated noise enhancement mask output by the noise enhancement mask estimation model that relatively reduces volume of time and frequency bands of the target speech included in the input speech. The information processing apparatus 1 updates the parameters included in the speech enhancement mask estimation model using the difference between the estimated value and the target value of the speech enhancement mask, the difference between the estimated value and the target value of the noise enhancement mask, and the constraint loss, thereby generating the speech enhancement mask estimation model capable of accurately performing speech enhancement.

### 2: Second Example Embodiment

Next, a second embodiment of the information processing apparatus, information processing method, and recording medium will be described. The second embodiment of the information processing apparatus, information processing method, and recording medium will be described using an information processing apparatus 2 to which the second embodiment of the information processing apparatus, information processing method, and recording medium is applied.

### [2-1-1: Speech and Noise]

In this embodiment, “the speech” refers to a target sound signal. In this embodiment, “the speech” may be referred to as “target signal.” In this embodiment, “the noise” refers to a sound signal that is not the target. In this embodiment, the ‘noise’ may be referred to as “non-target signal.”

The speech may be a sound that is of interest. The speech may be a human voice. The speech may be a speech from a specific person. The specific person may be one or more persons. The specific person may be a person located near a mechanism for acquiring sound, such as a microphone. “The speech” may represent different sound signals depending on the situation.

In this embodiment, “the noise-mixed speech” is the ‘speech’ mixed with “the noise.” “The noise-mixed speech” includes “the speech” which is the target sound signal, and “the noise” which is not the target sound signal. The sound signal included in “the noise-mixed speech” is either “the speech” or “the noise” In other words, the sound signal included in “the noise-mixed speech” that is not “the speech” is “the noise” Furthermore, the sound signal included in “the noise-mixed speech” that is not the ‘noise’ is “the speech” In this embodiment, the input signal input to the information processing apparatus 2 is the noise-mixed speech. In other words, the input signal input to the information processing apparatus 2 consists of the target signal, which is the speech, and the non-target signal, which is the noise.

### [2-1-2: Speech Enhancement Technology]

A microphone may pick up noise other than speech mixed in with speech. In such case, the larger the noise is relative to the speech, the more difficult it becomes to hear the speech. The speech enhancement technology is a technology for increasing the volume of speech relative to the noise from the noise-mixed speech. This technology may be a technology for suppressing the noise from the noise-mixed speech, enhancing the speech, and providing the speech that is easier to hear. This technology may also be a technology for enhancing only the speech from the noise-mixed speech, providing a more intelligible speech. The speech enhancement technology may be capable of removing noise from a speech of the person on the other end of the line in a high-noise environment. Additionally, the speech enhancement technology may enhance the speech of the person on the other end of the line, allowing for smoother communication. Furthermore, the speech enhancement technology may improve the recognition rate of a speech recognition system.

Additionally, a speech enhancement technology using mask estimates the speech enhancement mask that specifies time and frequency band for reducing the noise, and amount of reduction. The speech enhancement technology using mask may be a technology that makes the speech easier to hear by applying the speech enhancement mask to the noise-mixed speech. In this embodiment, in the speech enhancement technology using mask, the speech enhancement mask estimation model that estimates the speech enhancement mask may be machine learned. The speech enhancement mask estimation model created in this embodiment may be applied to situations where the speech is to be emphasized.

The speech enhancement mask estimation model created in this embodiment is trained using noise-mixed speech, which is clean speech with noise superimposed on it, as the input signal. The clean speech may be speech with very little noise. The machine learning in this embodiment may be deep learning.

### [2-1-3: The Speech Enhancement Mask and the Noise Enhancement Mask]

The speech enhancement mask estimation model is a model that outputs the speech enhancement mask in case the noise-mixed speech is input. The speech enhancement mask estimated by the speech enhancement mask estimation model may be called the estimated speech enhancement mask. The estimated speech enhancement mask may be referred to as the estimated value. The speech enhancement mask may be expressed as shown in the following equation 1.

$${M}_{S} ( f , t ) = \frac{{S ( f , t )}^{2}}{{S ( f , t )}^{2} + {N ( f , t )}^{2}} \qquad [ Equation l ]$$

S (t, f)² indicates the power of “the speech” N (t, f)² indicates the power of “the noise”

The speech enhancement mask is expressed as the ratio of the power of “the speech” to the power of “the noise-mixed speech.”

As described above, in this embodiment, the speech enhancement mask estimation model is created by training it for the purpose of emphasizing speech, but it is expected that training it to emphasize noise along with speech will promote the training of the speech enhancement mask estimation model.

The noise enhancement mask relatively reduces the volume at the time and frequency band of the target speech included in the input speech. The noise enhancement mask estimation model is a model that outputs the noise enhancement mask in case the noise-mixed speech is input. The noise enhancement mask estimated by the noise enhancement mask estimation model may also be referred to as the estimated noise enhancement mask. The estimated noise enhancement mask is sometimes referred to as the estimated value. The noise enhancement mask can also be expressed as shown in Equation 2 below.

$${M}_{N} ( f , t ) = \frac{{N ( f , t )}^{2}}{{S ( f , t )}^{2} + {N ( f , t )}^{2}} \qquad [ Equation 2 ]$$

The noise enhancement mask represents the ratio of the power of “the noise” to the power of “the noise-mixed speech.”

### [2-1-4: Training]

The information processing apparatus 2 may create the speech enhancement mask estimation model capable of estimating a speech enhancement mask that is ideal by training the speech enhancement mask estimation model and the noise enhancement mask estimation model. The speech enhancement mask estimation model and the noise enhancement mask estimation model may be implemented using a neural network (NN). The speech enhancement mask estimation model and the noise enhancement mask estimation model may be implemented using a recurrent neural network (RNN). The information processing apparatus 2 may update the parameters included in the speech enhancement mask estimation model and the parameters included in the noise enhancement mask estimation model according to the estimated value from the speech enhancement mask estimation model and the estimated value from the noise enhancement mask estimation model, and create the speech enhancement mask estimation model that can estimate the speech enhancement mask that is ideal.

A training input signal, and the speech enhancement mask that is ideal and the noise enhancement mask corresponding to the training input signal, are prepared in advance. The speech enhancement mask that is ideal (also referred to as “the target speech enhancement mask”) is the speech enhancement mask calculated in case the speech and noise in the noise-mixed speech are known. The noise enhancement mask that is ideal (also referred to as “the target noise enhancement mask”) is the noise enhancement mask calculated in case the speech and noise in the noise-mixed speech are known.

Hereinafter, the terms “the speech enhancement mask that is ideal” and “the noise enhancement mask that is ideal” will be used to describe the processing related to the information processing apparatus 2.

The training input signal is an input signal for which the speech enhancement mask that is ideal and the noise enhancement mask are prepared in advance. As described above, the input signal may consist of the target signal, which is the speech, and the non-target signal, which is the noise. The speech enhancement mask that is ideal may be referred to as an ideal speech enhancement mask or an ideal value. Similarly, the noise enhancement mask that is ideal may be referred to as an ideal noise enhancement mask or the ideal value. Additionally, the information including the training input signal and the ideal value may be referred to as training information. The training information may be stored in a training information storage unit 222 described later. The ideal value may also serve as the target value for parameter updates.

### 2-2: Configuration of the Information Processing Apparatus 2

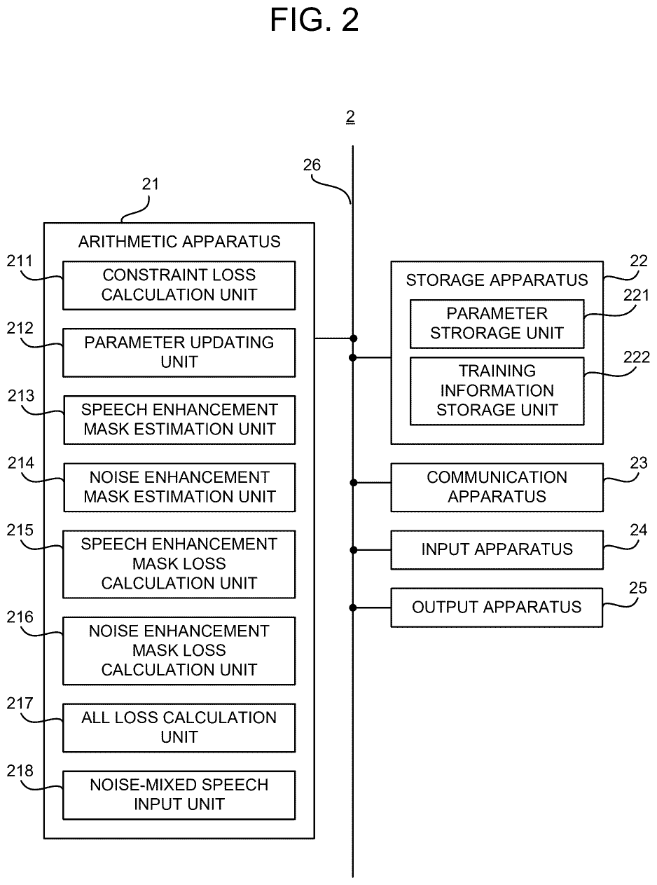

FIG. 2 is a block diagram showing the configuration of the information processing apparatus 2 according to the second embodiment. As shown in FIG. 2, the information processing apparatus 2 is provided with an arithmetic apparatus 21 and a storage apparatus 22. Furthermore, the information processing apparatus 2 may include a communication apparatus 23, an input apparatus 24, and an output apparatus 25. However, the information processing apparatus 2 may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 may be, for example, a CPU (Central Processing Unit), a GPU (Graphics Processing Unit), and/or an FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-temporary recording medium using a recording medium reading apparatus (e.g., the input apparatus 24 described later) provided in the information processing apparatus 2. The arithmetic apparatus 21 may obtain (i.e., download or read) a computer program from an apparatus not shown, which is disposed outside the information processing apparatus 2, via the communication apparatus 23 (or other communication apparatus). The arithmetic apparatus 21 executes the read computer program. As a result, logical functional blocks for executing the operations to be performed by the information processing apparatus 2 are realized within the arithmetic apparatus 21. In other words, the arithmetic apparatus 21 functions as a controller for realizing logical functional blocks for executing the operations (i.e., processing) to be performed by the information processing apparatus 2.

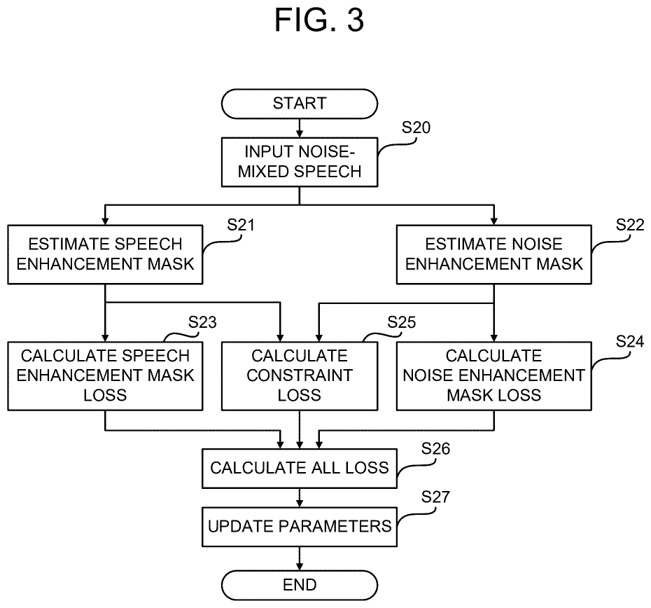

FIG. 2 shows an example of logical functional blocks realized within the arithmetic apparatus 21 for executing information processing operations. As shown in FIG. 2, the arithmetic apparatus 21 includes a constraint loss calculation unit 211, which is a specific example of “constraint loss calculation unit” described in the Supplementary Note described later, a parameter update unit 212, which is a specific example of “parameter update unit” described in the Supplementary Note described later, and a speech enhancement mask estimation unit 213, which is a specific example of “speech enhancement mask estimation unit” described in the Supplementary Note described later, a noise enhancement mask estimation unit 214, which is a specific example of “noise enhancement mask estimation unit” described in the supplementary note described below, and a speech enhancement mask loss calculation unit 215, which is a specific example of “speech enhancement mask loss calculation unit” described in the supplementary note described below, a noise enhancement mask loss calculation unit 216, which is a specific example of “noise enhancement mask loss calculation unit” described in the supplementary note described later, an all loss calculation unit 217, which is a specific example of “all loss calculation unit” described in the supplementary note described later, and a noise-mixed speech input unit 218 are realized. The speech enhancement mask estimation unit 213 estimates the speech enhancement mask using the speech enhancement mask estimation model, which is a specific example of the speech enhancement mask estimation model described in the supplementary note described below. The noise enhancement mask estimation unit 214 estimates the noise enhancement mask using the noise enhancement mask estimation model, which is a specific example of the noise enhancement mask estimation model described in the supplementary note described later. However, the arithmetic apparatus 21 may not necessarily include any of the speech enhancement mask estimation unit 213, the noise enhancement mask estimation unit 214, the speech enhancement mask loss calculation unit 215, the noise enhancement mask loss calculation unit 216, the all loss calculation unit 217, and the noise-mixed speech input unit 218 may be omitted. The constraint loss calculation unit 211, the parameter update unit 212, the speech enhancement mask estimation unit 213, the noise enhancement mask estimation unit 214, the speech enhancement mask loss calculation unit 215, the noise enhancement mask loss calculation unit 216, the all loss calculation unit 217, and the noise-mixed speech input unit 218 will be explained in detail later with reference to FIG. 3.

The storage apparatus 22 is capable of storing desired data. For example, the storage apparatus 22 may temporarily store the computer program executed by the arithmetic apparatus 21. The storage apparatus 22 may temporarily store data temporarily used by the arithmetic apparatus 21 in case the arithmetic apparatus 21 is executing the computer program. The storage apparatus 22 may store data that the information processing apparatus 2 stores for long-term preservation. Note that the storage apparatus 22 may be RAM (Random Access Memory), ROM (Read Only Memory), a hard disk apparatus, an optical magnetic disk apparatus, an SSD (Solid State Drive), and a disk array apparatus. In other words, the storage apparatus 22 may include a non-temporary recording medium. The storage apparatus 22 may realize a parameter storage unit 221 and the training information storage unit 222. The parameter storage unit 221 stores the parameters included in the speech enhancement mask estimation model and the parameters included in the noise enhancement mask estimation model. However, the storage apparatus 22 may not realize either the parameter storage unit 221 or the training information storage unit 222.

The communication apparatus 23 is capable of communicating with an external apparatus of the information processing apparatus 2 via an unillustrated communication network. The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the information processing apparatus 2 from outside the information processing apparatus 2. For example, the input apparatus 24 may include an operation apparatus (e.g., at least one of a keyboard, a mouse, and a touch panel) that can be operated by an operator of the information processing apparatus 2. For example, the input apparatus 24 may include a reading apparatus capable of reading information recorded as data on a recording medium that can be attached to the information processing apparatus 2.

The output apparatus 25 is an apparatus that outputs information to the outside of the information processing apparatus 2. For example, the output apparatus 25 may output information as images. In other words, the output apparatus 25 may include a display apparatus (a so-called display) capable of displaying images indicating the information to be output. For example, the output apparatus 25 may output information as sound. In other words, the output apparatus 25 may include a sound apparatus (a so-called speaker) capable of outputting sound. For example, the output apparatus 25 may output information onto paper. In other words, the output apparatus 25 may include a printing apparatus (a so-called printer) capable of printing desired information onto paper.

### 2-3: Information Processing Operations Performed by the Information Processing Apparatus 2

Referring to FIG. 3, the information processing operations performed by the information processing apparatus 2 will be described. FIG. 3 is a flowchart showing the flow of information processing operations performed by the information processing apparatus 2.

As shown in FIG. 3, the noise-mixed speech input unit 218 acquires the noise-mixed speech and inputs it to the speech enhancement mask estimation unit 213 and the noise enhancement mask estimation unit 214 (step S20).

The speech enhancement mask estimation unit 213 estimates the speech enhancement mask using the speech enhancement mask estimation model (step S21). The speech enhancement mask estimation unit 213 outputs, as an estimated value, the estimated speech enhancement mask output by the speech enhancement mask estimation model to which noise-mixed speech has been input.

The noise enhancement mask estimation unit 214 estimates the noise enhancement mask using the noise enhancement mask estimation model (step S22). The noise enhancement mask estimation unit 214 outputs, as an estimated value, the estimated noise enhancement mask output by the noise enhancement mask estimation model to which noise-mixed speech has been input.

### [2-3-1: Speech Enhancement Mask Loss]

The speech enhancement mask loss calculation unit 215 calculates the speech enhancement mask loss using the estimated speech enhancement mask estimated by the speech enhancement mask estimation model and the ideal speech enhancement mask that is ideal (step S23). The speech enhancement mask loss indicates the difference between the estimated speech enhancement mask and the ideal speech enhancement mask. The speech enhancement mask loss may be calculated using a speech enhancement mask loss function L_{S}. The speech enhancement mask loss function L_{S} may be expressed as shown in the following equation 3. That is, the speech enhancement mask loss function L_{S} may be expressed as the sum of the squares of the differences between the estimated values and the ideal values at each time in the frequency bin. M_{S} represents the estimated value of the speech enhancement mask. M_{S}ⁱ represents the ideal value of the speech enhancement mask.

$${L}_{S} = M S E ( {M}_{S} ; {M}_{S}^{i} ) = {\sum }_{f , t} {( {M}_{S} - {M}_{S}^{i} )}^{2} \qquad [ Equation 3 ]$$

In the following, matters related to each time in the frequency domain may be expressed using the term “time-frequency”.

### [2-3-2: Noise Enhancement Mask Loss]

The noise enhancement mask loss calculation unit 216 calculates the noise enhancement mask loss using the estimated noise enhancement mask estimated by the noise enhancement mask estimation model and the ideal noise enhancement mask that is ideal (step S24). The noise enhancement mask loss indicates the difference between the estimated noise enhancement mask and the ideal noise enhancement mask. The noise enhancement mask loss may be calculated using a noise enhancement mask loss function L_{N}. The noise enhancement mask loss function L_{N} may be expressed as shown in the following equation 4. That is, the noise enhancement mask loss function L_{N} may be expressed as the sum of the squares of the differences between the estimated values and the ideal values in the time-frequency. M_{N} represents the estimated values of the noise enhancement mask. Furthermore, M_{N}ⁱ represents the ideal value of the noise enhancement mask.

$${L}_{N} = M S E ( {M}_{N} ; {M}_{N}^{i} ) = {\sum }_{f , t} {( {M}_{N} - {M}_{N}^{i} )}^{2} \qquad [ Equation 4 ]$$

### [2-3-3: Constraint Loss]

From the speech enhancement mask expressed by the above equation 1 and the noise enhancement mask expressed by the above equation 2, the following equation 5 can be established. That is, the sum of the speech enhancement mask and the noise enhancement mask related to the time-frequency is ideally a constant value “1”. In this embodiment, this is used as a constraint.

$${M}_{S} + {M}_{N} = \frac{{S ( f , t )}^{2}}{{S ( f , t )}^{2} + {N ( f , t )}^{2}} + \frac{{N ( f , t )}^{2}}{{S ( f , t )}^{2} + {N ( f , t )}^{2}} = 1 \qquad [ Equation 5 ]$$

The constraint loss calculation unit 211 calculates the constraint loss using the estimated speech enhancement mask estimated by the speech enhancement mask estimation model and the estimated noise enhancement mask estimated by the noise enhancement mask estimation model (step S25). The constraint loss indicates the difference between the estimated value of the sum of the speech enhancement mask and the noise enhancement mask (the constraint) and the ideal value.

The loss function is designed so that in case the constraint conditions are violated, that is, as the value acquired from the following equation 6 moves away from “0”, a penalty is imposed. The constraint loss according to this embodiment can be acquired from the following equation 6.

$$\frac{{S ( f , t )}^{2}}{{S ( f , t )}^{2} + {N ( f , t )}^{2}} + \frac{{N ( f , t )}^{2}}{{S ( f , t )}^{2} + {N ( f , t )}^{2}} - 1 \qquad [ Equation 6 ]$$

In this embodiment, the constraint is introduced as information related to both the speech and the noise. The constraint may be used as information related to both the speech and the noise in case of updating the parameters described later. For example, in the above Equation 6, in case the value acquired is greater than “0,” i.e., in case M_{S}+M_{N} is greater than “1,” the parameters of the speech enhancement mask may be updated to strengthen speech enhancement, and the parameters of the noise enhancement mask may also be updated to strengthen noise enhancement. Conversely, in case the value acquired in the above equation 6 is less than “0,” that is, in case M_{S}+M_{N} is less than “1,” the parameters of the speech enhancement mask may be updated to weaken speech enhancement, and the parameters of the noise enhancement mask may also be updated to weaken noise enhancement.

A loss function can be derived based on the amount by which the speech enhancement mask estimated and the noise enhancement mask estimated deviate from the constraint. In this embodiment, a constraint loss function L_{SN} shown in the following equation 7 may be introduced as the constraint. The following equation 7 calculates the sum of the time-frequency.

$${L}_{SN} = MSE ( {M}_{S} + {M}_{N} ; 1 ) = {\sum }_{f , t} {( {M}_{S} + {M}_{N} - 1 )}^{2} \qquad [ Equation 7 ]$$

The constraint loss function L_{SN} has a loss in case it exceeds “0.” By introducing this constraint, even in case one of the estimated values of the speech enhancement mask and the noise enhancement mask is correct, the value of the loss function increases in case the other estimated value is incorrect. Compared to a comparison example where the speech enhancement mask and the noise enhancement mask are trained independently, the model can be trained to achieve accurate estimation.

### [2-3-4: Total Loss]

The all loss calculation unit 217 calculates the total loss by summing the speech enhancement mask loss, the noise enhancement mask loss, and the constraint loss (Step S26). The total loss may be calculated using an all loss function L_{ALL}. The all loss function L_{ALL} may be expressed as shown in the following Equation 8. The total loss acquired from the all loss function L_{ALL} may also be referred to as an all loss.

$${L}_{ALL} = {L}_{S} + {L}_{N} + λ {L}_{SN} \qquad [ Equation 8 ]$$

λ may be a value between “0” and “1.” λ may be a positive number less than 1, λ may be a value smaller than “1,” such as “0.01” or “0.1.” λ may be constant or may be changed during the model training process. λ may be particularly small at the start of the model training process and may be large at the end.

Note that in the above Equation 8, the same weight is assigned to the speech enhancement mask loss function L_{S} and the noise enhancement mask loss function L_{N} in the summation. However, different weights may be assigned to the speech enhancement mask loss function L_{S} and the noise enhancement mask loss function L_{N}. For example, the all loss may be calculated using the all loss function L_{ALL} shown in the following Equation 9.

$${L}_{ALL} = {aL}_{S} + {bL}_{N} + λ {L}_{SN} \qquad [ Equation 9 ]$$

The values of “a” and “b” may be different. The values of “a” and “b” may also be the same. In case both “a” and ‘b’ are “1,” Equation 9 is equivalent to Equation 8.

### [2-3-5: Parameter Update]

The parameter update unit 212 updates the parameters included in the speech enhancement mask estimation model and the parameters included in the noise enhancement mask estimation model according to the calculation results of the all loss calculation unit 217 (step S27). The parameter update unit 212 updates the parameters included in the speech enhancement mask estimation model and the parameters included in the noise enhancement mask estimation model using the speech enhancement mask loss indicating the difference between the estimated speech enhancement mask and the ideal speech enhancement mask that is ideal, the noise enhancement mask loss indicating the difference between the estimated noise enhancement mask and the ideal noise enhancement mask that is ideal, and the constraint loss. The parameter update unit 212 updates the parameters included in the speech enhancement mask estimation model and the parameters included in the noise enhancement mask estimation model stored in the parameter storage unit 221. The parameter update unit 212 may update the parameters of the speech enhancement mask estimation model and the parameters of the noise enhancement mask estimation model using, for example, backpropagation.

The information processing apparatus 2 according to this embodiment can promote training of both the speech enhancement mask estimation model and the noise enhancement mask estimation model through the constraint loss function L_{SN}. The speech enhancement mask estimation model can be trained using information combined from the information included in the speech enhancement mask estimation model and the information included in the noise enhancement mask estimation model.

### 2-4: Allowable Range of the Constraint

As mentioned above, the sum of the speech enhancement mask and the noise enhancement mask is ideally “1,” and in this embodiment, this is used as the constraint. On the other hand, this constraint does not necessarily have to be strictly “1.” In this case, for example, as shown in the following equation 10, ‘1’ can be replaced with “1+ε.”

$$[ Equation 10 ]$$

$${M}_{S} + {M}_{N} = \frac{{S ( f , t )}^{2}}{{S}^{{i}^{2}} ( f , t ) + {{N}^{i} ( f , t )}^{2}} + \frac{{N ( f , t )}^{2}}{{S}^{{i}^{2}} ( f , t ) + {{N}^{i} ( f , t )}^{2}} = 1 + ε$$

“ε” is a very small positive number compared to “1.” By replacing “1” with “1+ε,” an error of approximately ‘ε’ can be tolerated. “ε” may be arbitrarily changed depending on the design. In the denominator of the above Equation 10, Sⁱ and Nⁱ represent ideal values, while S and N represent estimated values.

In case “1” is replaced with “1+ε,” the constraint loss function L_{SN} can be expressed as in the following Equation 11.

$${L}_{SN} = MSE ( {M}_{S} + {M}_{N} ; 1 + ε ) = \sum {( {M}_{S} + {M}_{N} - ( 1 + ε ) )}^{2} \qquad [ Equation 11 ]$$

From the constraint loss acquired from the constraint loss function L_{SN}, it is unclear whether the speech enhancement mask or the noise enhancement mask is larger or smaller than the ideal value. In case the sum of the speech enhancement mask and the noise enhancement mask exceeds “1,” i.e., in case a positive ‘ε’ is adopted, at least one of the estimated speech enhancement mask and the estimated noise enhancement mask is larger than the ideal value. In other words, adopting a positive “ε” may result in incomplete suppression of noise from the speech. Therefore, in cases where some noise is acceptable, a positive “ε” may be permitted.

On the other hand, in case the sum of the speech enhancement mask and the noise enhancement mask is less than “1,” i.e., in case a negative “ε” is adopted, at least one of the estimated speech enhancement mask and the estimated noise enhancement mask is smaller than the ideal value. In other words, adopting a negative “ε” may result in excessive reduction of the speech that should be retained. Excessive reduction of speech makes it difficult to understand, so negative ‘ε’ values are not permitted. The parameter update unit 212 updates the parameters so that the sum of the speech enhancement mask and the noise enhancement mask is not less than “1.”

### 2-5: Modified Example

In case the speech includes speech from multiple persons, the speech enhancement mask estimation unit 213 may estimate speech enhancement masks corresponding to each of the multiple persons. The speech enhancement mask estimation model corresponding to each person is provided, and each speech enhancement mask estimation model may output the speech enhancement mask corresponding to the person.

For example, in case the speech includes speeches from person A and person B, the speech enhancement mask estimation model A corresponding to a speech from person A and the speech enhancement mask estimation model B corresponding to a speech from person B may be trained. The speech enhancement mask estimation model A outputs the speech enhancement mask M_{SA} corresponding to the speech from person A in case the noise-mixed speech is input, and the speech enhancement mask estimation model B outputs the speech enhancement mask M_{SB} corresponding to the speech from person B in case the noise-mixed speech is input.

The constraint for outputting the speech enhancement mask M_{SA} and the speech enhancement mask M_{SB} may be expressed as shown in the following equation 12.

$${M}_{SA} + {M}_{SB} + {M}_{N} = \frac{SA {( f , t )}^{2}}{SA {( f , t )}^{2} + {SB ( f , t )}^{2} + N {( f , t )}^{2}} + \frac{SB {( f , t )}^{2}}{SA {( f , t )}^{2} + {SB ( f , t )}^{2} + N {( f , t )}^{2}} + \frac{N {( f , t )}^{2}}{S {A ( f , t )}^{2} + S {B ( f , t )}^{2} + {N ( f , t )}^{2}} = 1 \qquad [ Equation 12 ]$$

In this embodiment, an example of a loss function using mean square error is given, but a loss function using a method other than mean square error may also be adopted.

### 2-6: Technical Effects of the Information Processing Apparatus 2

For example, the above non-patent literature 1 describes a technique for estimating the speech enhancement mask and the noise enhancement mask using a model, calculating the difference between the estimated values and the ideal values as loss, and training the model. The technique described in the above non-patent literature 1 is referred to as a comparative example. In the comparative example, the information estimated by the model for the noise enhancement mask is not used to evaluate the speech enhancement mask estimated by the model. Similarly, the information estimated by the model for the speech enhancement mask is not used to evaluate the noise enhancement mask estimated by the model. In other words, the speech enhancement mask estimated and the noise enhancement mask estimated are evaluated independently of each other.

As described above, the input signal includes speech and noise (as described above, in this embodiment, anything other than the speech is referred to as “the noise”). Therefore, the sum of the ideal value of the speech enhancement mask and the ideal value of the noise enhancement mask is a constant value “1”. As mentioned above, in case the sum of the speech enhancement mask and the noise enhancement mask exceeds “1,” at least one of the estimated values of the speech enhancement mask and the noise enhancement mask is significantly larger than the ideal value, and it may not be possible to completely suppress noise from the speech. Furthermore, in case the sum of the speech enhancement mask and the noise enhancement mask is less than “1,” at least one of the estimated values of the speech enhancement mask and the noise enhancement mask is smaller than the ideal value, and there is a possibility that the speech that should be retained is excessively reduced. For example, in estimation where noise that changes rapidly in a short time is included in the input signal, the speech is often excessively reduced. In order to avoid removing too much speech, which would make the speech difficult to hear, it is particularly desirable to prevent removing too much speech.

In the comparison example, the speech enhancement mask estimated and the noise enhancement mask estimated are evaluated independently, and it is unclear whether the sum of the speech enhancement mask and the noise enhancement mask is equal to a constant value of “1.” Therefore, not only is it impossible to completely suppress noise from the speech, but there is also a risk of excessively reducing speech that should be retained. Additionally, noise types are diverse, and the accuracy of the noise enhancement mask is often lower than that of the speech enhancement mask. Using the independent evaluation of the noise enhancement mask for updating model parameters may result in reduced accuracy of speech enhancement.

The information processing apparatus 2 according to the second embodiment introduces the constraint loss calculated using the estimation results acquired by the speech enhancement mask estimation unit 213 and the estimation results acquired by the noise enhancement mask estimation unit 214. The total loss, which is the sum of the speech enhancement mask loss, the noise enhancement mask loss, and the constraint loss, is used to update the parameters included in the speech enhancement mask estimation model, thereby suppressing noise from the speech and preventing excessive reduction of the speech that should be retained. The information processing apparatus 2 can create the speech enhancement mask estimation model that can perform speech enhancement with high accuracy.

### 3: Third Example Embodiment

Next, the third embodiment of the information processing apparatus, information processing method, and recording medium will be described. In the following, the third embodiment of the information processing apparatus, information processing method, and recording medium will be described using an information processing apparatus 3 to which the third embodiment of the information processing apparatus, information processing method, and recording medium is applied.

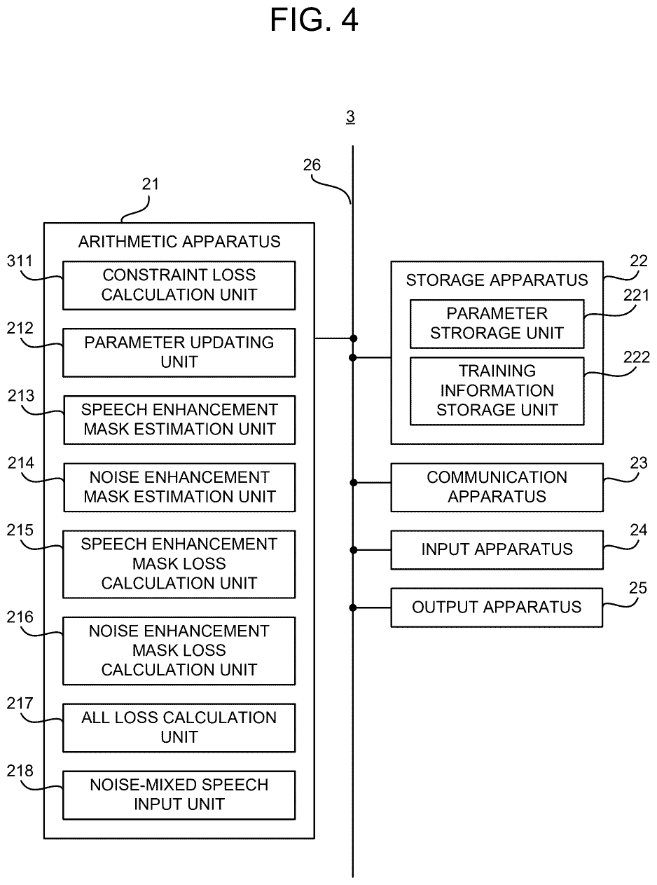

FIG. 4 is a block diagram showing the configuration of the information processing apparatus 3 according to the third embodiment. The information processing apparatus 3 according to the third embodiment differs from the information processing apparatus 2 according to the second embodiment in that the operation of a constraint loss calculation unit 311 is different.

### 3-1: Information Processing Operations Performed by the Information Processing Apparatus 3

In the third embodiment, the constraint loss calculation unit 311 calculates the constraint loss by multiplying the estimated speech enhancement mask and the estimated noise enhancement mask by a volume of the noise-mixed speech. The constraint loss calculation unit 311 may calculate the constraint loss by multiplying the estimated speech enhancement mask and the estimated noise enhancement mask in the time-frequency by the volume of the noise-mixed speech. The volume of the noise-mixed speech may be the absolute value of the magnitude of the noise-mixed speech. The volume of the noise-mixed speech may be the Log power spectrum of the noise-mixed speech. The volume of the noise-mixed speech may be a normalized value. This value may be arbitrarily changed depending on the design.

In case the volume of the noise-mixed speech is expressed as LPSᵢₙₚᵤₜ, the constraint loss function L_{SN} in the third embodiment may be expressed as shown in the following equation 13.

$$[ Equation 13 ]$$

$${L}_{SN} = {LPS}_{Input} \times MSE ( {M}_{S} + {M}_{N} ; 1 ) = {\sum }_{f , t} {LPS}_{Input} \times {( {M}_{S} + {M}_{N} - 1 )}^{2}$$

Multiplying by LPSᵢₙₚᵤₜ allows greater emphasis on errors associated with the time-frequency where LPSᵢₙₚᵤₜ is large. This corresponds to the application of magnitude spectrum approximation (MSA).

Multiplying by LPSᵢₙₚᵤₜ is effective in case of training short-duration, rapidly varying noise, such as the sound of a bullet train passing by. This assigns greater weight to larger input signals than to smaller input signals, thereby emphasizing errors related to larger input signals.

### 3-2: Technical Effects of the Information Processing Apparatus 3

The information processing apparatus 3 according to the third embodiment multiplies the volume of the noise-mixed speech, thereby suppressing noise related to particularly large input signals.

### 4: Fourth Example Embodiment

Next, the fourth embodiment of the information processing apparatus, information processing method, and recording medium will be described. In the following, the fourth embodiment of the information processing apparatus, information processing method, and recording medium will be described using an information processing apparatus 4 to which the fourth embodiment of the information processing apparatus, information processing method, and recording medium is applied.

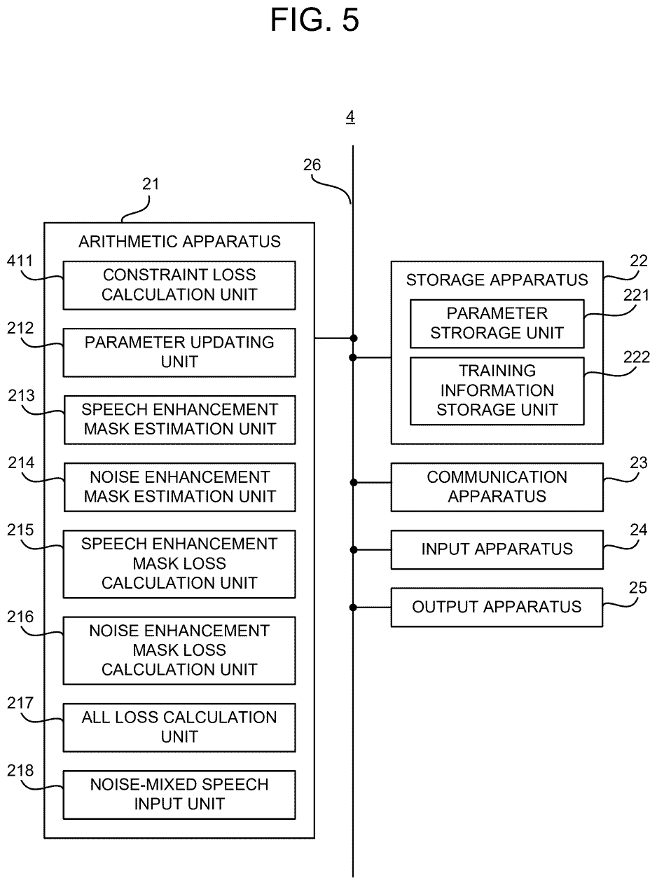

FIG. 5 is a block diagram showing the configuration of the information processing apparatus 4 according to the fourth embodiment. The information processing apparatus 4 according to the fourth embodiment differs from the information processing apparatus 2 according to the second embodiment and the information processing apparatus 3 according to the third embodiment in that the operation of a constraint loss calculation unit 411 is different.

### 4-1: Information Processing Operation Performed by the Information Processing Apparatus 4

In the fourth embodiment, the constraint loss calculation unit 411 calculates the constraint loss by raising the estimated speech enhancement mask and the estimated noise enhancement mask to a predetermined exponent. The constraint loss calculation unit 411 may calculate the constraint loss by raising the estimated speech enhancement mask and the estimated noise enhancement mask in the time-frequency to the predetermined exponent. The predetermined exponent may take values of 0 or more and 1 or less.

In case the predetermined exponent is expressed as α, the constraint loss function L_{SN} of the fourth embodiment may be expressed as shown in the following equation 14.

$${L}_{SN} = MSE ( {M}_{S}^{α} + {M}_{N}^{α} ; 1 ) \qquad [ Equation 14 ]$$

In case of raised to the power of α, it is possible to train more intensively, for example, steady noise such as the sound of an air conditioner. This can be expected to have an effect equivalent to the application of the power law compression.

In the fourth embodiment, the LPSᵢₙₚᵤₜ applied in the third embodiment may also be applied. In this case, the constraint loss function L_{SN} of the fourth embodiment may be expressed as shown in the following equation 15.

$${L}_{SN} = {LPS}_{Input} \times MSE ( {M}_{S}^{α} + {M}_{N}^{α} ; 1 ) \qquad [ Equation 15 ]$$

### 4-2: Technical Effects of the Information Processing Apparatus 4

The information processing apparatus 4 of the fourth embodiment can train small signals with greater emphasis by applying a.

### 5: Fifth Example Embodiment

Next, the fifth embodiment of the information processing apparatus, information processing method, and recording medium will be described. In the following, the fifth embodiment of the information processing apparatus, information processing method, and recording medium will be described using an information processing apparatus 5 to which the fifth embodiment of the information processing apparatus, information processing method, and recording medium is applied.

### 5-1: Configuration of the Information Processing Apparatus 5

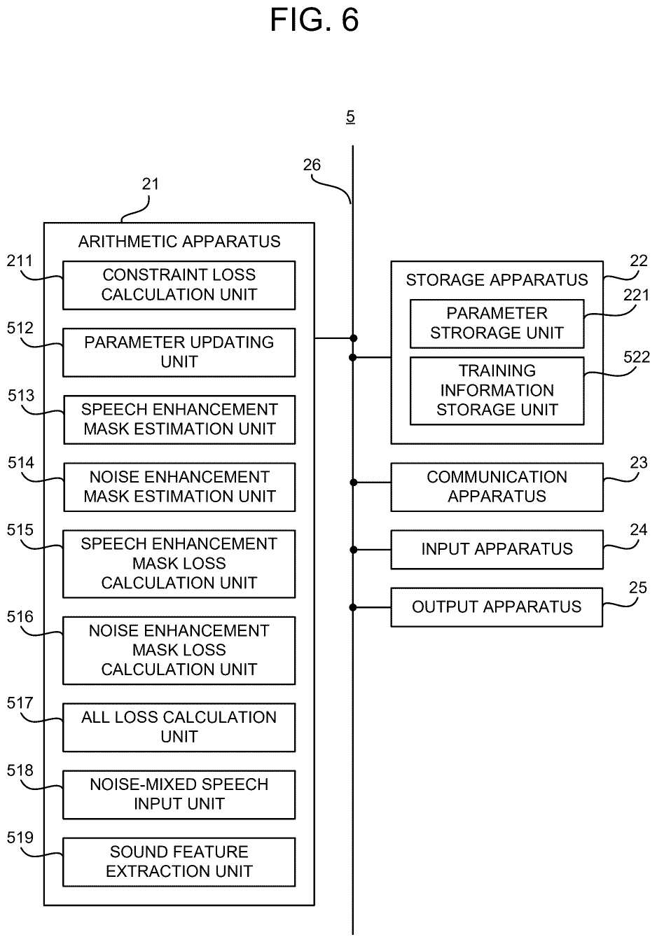

As shown in FIG. 6, the information processing apparatus 5 according to the fifth embodiment is provided with the arithmetic apparatus 21 and the storage apparatus 22, as in from the information processing apparatus 2 according to the second embodiment through the information processing apparatus 4 according to the fourth embodiment. Furthermore, the information processing apparatus 5 according to the fifth embodiment may include the communication apparatus 23, the input apparatus 24, and the output apparatus 25, as in the information processing apparatus 2 according to the second embodiment through the information processing apparatus 4 according to the fourth embodiment. However, the information processing apparatus 5 may not necessarily include at least one of the communication apparatus 23, the input apparatus 24, and the output apparatus 25. The information processing apparatus 5 according to the fifth embodiment differs from the information processing apparatus 2 according to the second embodiment through the information processing apparatus 4 according to the fourth embodiment in that a sound feature extraction unit 519 is further provided in the arithmetic apparatus 21. Other features of the information processing apparatus 5 may be the same as at least one other feature of the information processing apparatus 2 according to the second embodiment through the information processing apparatus 4 according to the fourth embodiment. For this reason, the following description will explain in detail the parts that differ from the embodiments already described, and omit explanations of other overlapping parts as appropriate.

### 5-2: Information Processing Operations Performed by the Information Processing Apparatus 5

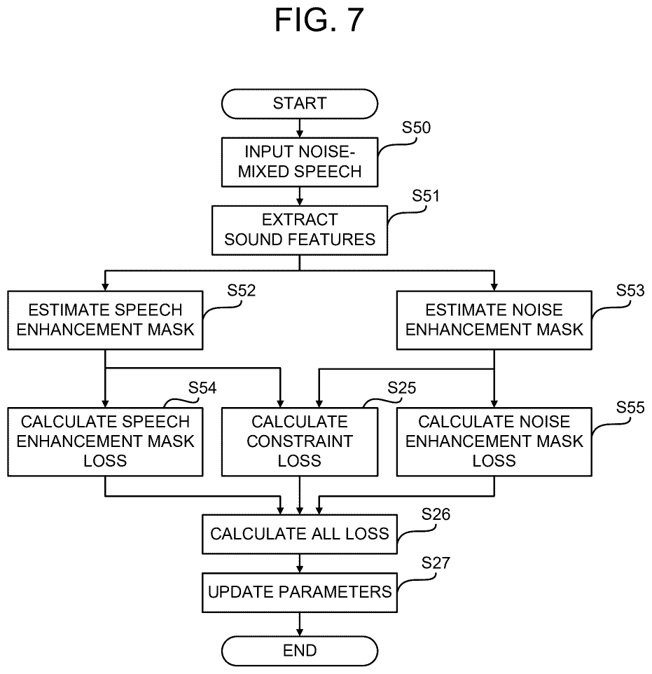

Referring to FIG. 7, the information processing operations performed by the information processing apparatus 5 will be described. FIG. 7 is a flowchart showing the flow of information processing operations performed by the information processing apparatus 5.

As shown in FIG. 7, a noise-mixed speech input unit 518 acquires the noise-mixed speech and inputs it to the sound feature extraction unit 519 (step S50). The sound feature extraction unit 519 extracts noise-mixed speech features, which are features of the noise-mixed speech, from the noise-mixed speech (step S51). The sound feature extraction unit 519 may have a sound features extraction model that receives the noise-mixed speech as input and outputs the noise-mixed speech features. The sound features extraction model may be implemented by an RNN.

A speech enhancement mask estimation unit 513 estimates the speech enhancement mask using the speech enhancement mask estimation model (step S52). In the fifth embodiment, the speech enhancement mask estimation model may be input with the noise-mixed speech features and output the estimated speech enhancement mask. The speech enhancement mask estimation unit 513 may output the estimated speech enhancement mask estimated from the noise-mixed speech features input to the speech enhancement mask estimation model as an estimated value.

A noise enhancement mask estimation unit 514 estimates the noise enhancement mask using the noise enhancement mask estimation model (step S53). In the fifth embodiment, the noise enhancement mask estimation model may be input with the noise-mixed speech features and output the estimated noise enhancement mask. The noise enhancement mask estimation unit 514 may output the estimated noise enhancement mask output by the noise enhancement mask estimation model with the noise-mixed speech features as an estimated value.

A speech enhancement mask loss calculation unit 515 calculates the speech enhancement mask loss using the estimated speech enhancement mask estimated by the speech enhancement mask estimation model and the ideal speech enhancement mask (step S54). The ideal speech enhancement mask may be a speech enhancement mask that is ideal for the noise-mixed speech features extracted from the training input signal.

A noise enhancement mask loss calculation unit 516 calculates the noise enhancement mask loss using the estimated noise enhancement mask estimated by the noise enhancement mask estimation model and the ideal noise enhancement mask (Step S55). The ideal noise enhancement mask may be a noise enhancement mask that is ideal for the noise-mixed speech features extracted from the training input signal.

The constraint loss calculation unit 211 calculates the constraint loss using the estimated speech enhancement mask estimated by the speech enhancement mask estimation model and the estimated noise enhancement mask estimated by the noise enhancement mask estimation model (step S25). The all loss calculation unit 217 calculates the total loss by summing the speech enhancement mask loss, the noise enhancement mask loss, and the constraint loss (step S26).

A parameter update unit 512 updates the parameters included in the sound features extraction model together with the parameters included in the speech enhancement mask estimation model and the noise enhancement mask estimation model according to the calculation results of the all loss calculation unit 217 (step S56). The sound features extraction model may be trained using both information related to speech and information related to noise.

The information processing apparatus 5 according to the fifth embodiment was created by machine learning using the speech enhancement mask estimation model and the sound features extraction model. In the fifth embodiment, in addition to the speech enhancement mask estimation model created, the sound features extraction model is applied in scenes where speech is to be enhanced.

### 5-3: Technical Effects of the Information Processing Apparatus 5

The information processing apparatus 5 according to the fifth embodiment is more preferable for speech enhancement because it can increase the input signals to both the speech enhancement mask estimation model and the noise enhancement mask estimation model by providing the sound feature extraction unit 519. On the other hand, as in the second embodiment, in case the sound feature extraction unit 519 is not provided, the operation can be made lighter.

For example, in the above-mentioned comparative example, by having the sound feature extraction unit 519, there is a possibility that the model parameters will be adjusted in a direction of excessively reducing one of the speech and noise signals during the backward propagation. In contrast, in the present embodiment, since the constraint loss calculated using the estimation results from the speech enhancement mask estimation model and the noise enhancement mask estimation model is introduced, even in case the sound feature extraction unit 519 is provided, the model parameters are not adjusted in a direction that excessively reduces one of the speech and noise signals during back propagation.

### 6: Sixth Example Embodiment

Next, the sixth embodiment of the information processing apparatus, information processing method, and recording medium will be described. In the following, the sixth embodiment of the information processing apparatus, information processing method, and recording medium will be described using an information processing apparatus 6 to which the sixth embodiment of the information processing apparatus, information processing method, and recording medium is applied.

### 6-1: Configuration of the Information Processing Apparatus 6

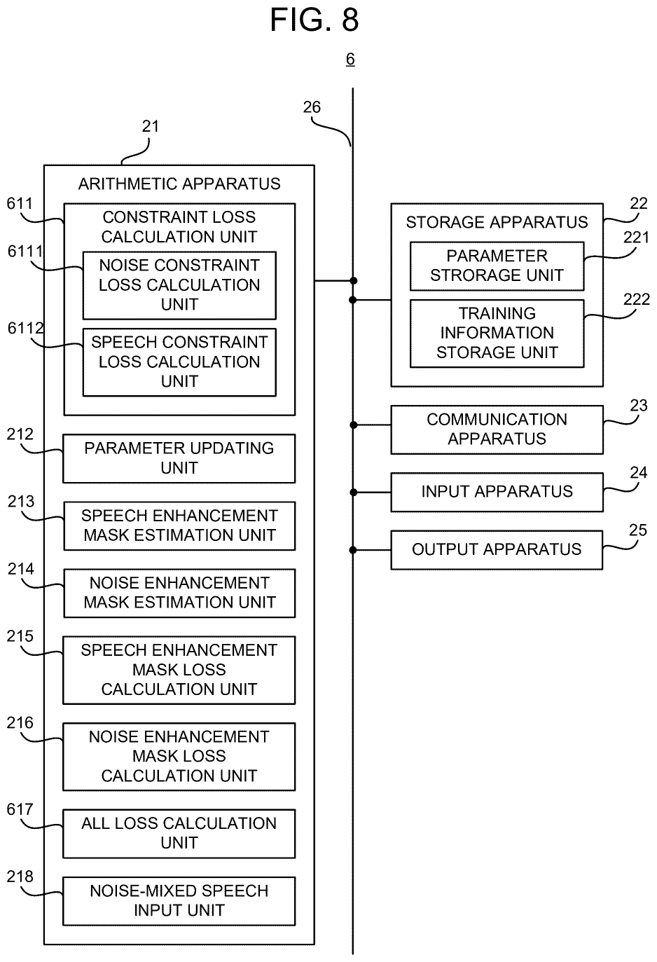

As shown in FIG. 8, the information processing apparatus 6 according to the sixth embodiment is provided with the arithmetic apparatus 21 and the storage apparatus 22, as in the information processing apparatus 2 according to the second embodiment through the information processing apparatus 5 according to the fifth embodiment. Furthermore, the information processing apparatus 6 according to the sixth embodiment may include the communication apparatus 23, the input apparatus 24, and the output apparatus 25, as in the information processing apparatus 2 according to the second embodiment through the information processing apparatus 5 according to the fifth embodiment. However, the information processing apparatus 6 may not include at least one of the communication apparatus 23, the input apparatus 24, and the output apparatus 25. The information processing apparatus 6 according to the sixth embodiment differs from the information processing apparatus 2 according to the second embodiment through the information processing apparatus 5 according to the fifth embodiment in that a constraint loss calculation unit 611 includes a noise constraint loss calculation unit 6111 and a speech constraint loss calculation unit 6112. Other features of the information processing apparatus 6 may be the same as at least one other feature of the information processing apparatus 2 according to the second embodiment through the information processing apparatus 5 according to the fifth embodiment. For this reason, the following describes in detail the parts that differ from the embodiments already described, and omits explanations of other overlapping parts as appropriate.

### 6-2: Information Processing Operations Performed by the Information Processing Apparatus 6

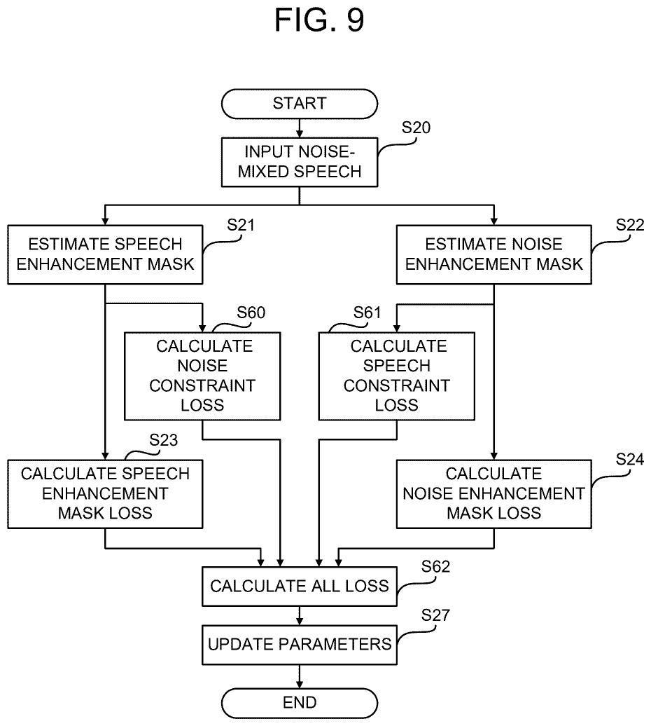

Referring to FIG. 9, the information processing operations performed by the information processing apparatus 6 will be described. FIG. 9 is a flowchart showing the flow of information processing operations performed by the information processing apparatus 6.

As shown in FIG. 9, the noise-mixed speech input unit 218 acquires the noise-mixed speech and inputs it to the speech enhancement mask estimation unit 213 and the noise enhancement mask estimation unit 214 (step S20). The speech enhancement mask estimation unit 213 estimates the speech enhancement mask using the speech enhancement mask estimation model (step S21). The noise enhancement mask estimation unit 214 estimates the noise enhancement mask using the noise enhancement mask estimation model (step S22). The speech enhancement mask loss calculation unit 215 calculates the speech enhancement mask loss using the estimated speech enhancement mask estimated by the speech enhancement mask estimation model and the ideal speech enhancement mask (step S23). The noise enhancement mask loss calculation unit 216 calculates the noise enhancement mask loss using the estimated noise enhancement mask estimated by the noise enhancement mask estimation model and the ideal noise enhancement mask (step S24).

### [6-2-1: Noise Constraint Loss]

The noise constraint loss calculation unit 6111 calculates the noise constraint loss using the estimated speech enhancement mask and the ideal noise enhancement mask (step S60). The noise constraint loss calculation unit 6111 calculates a constraint noise enhancement mask based on the estimated speech enhancement mask and the constraint expressed by the above equation 5. In case the constraint noise enhancement mask is represented as M_{N}*, the constraint noise enhancement mask may also be expressed as shown in the following equation 16.

$${M}_{N}^{*} = 1 - {M}_{S} \qquad [ Equation 16 ]$$

The noise constraint loss calculation unit 6111 calculates the noise constraint loss indicating the difference between the constraint noise enhancement mask and the ideal noise enhancement mask. In case the noise constraint loss is calculated by a noise constraint loss function L_{N}*, the noise constraint loss function L_{N}* may be expressed as shown in the following Equation 17.

$${L}_{N}^{*} = {M}_{N}^{*} - {M}_{N}^{i} = ( 1 - {M}_{S} ) - {M}_{N}^{i} \qquad [ Equation 17 ]$$

### [6-2-2: Speech Constraint Loss]

The speech constraint loss calculation unit 6112 calculates the speech constraint loss using the estimated noise enhancement mask and the ideal noise enhancement mask (step S61). The speech constraint loss calculation unit 6112 calculates a constraint speech enhancement mask based on the estimated noise enhancement mask and the constraint expressed in the above equation 5. In case the constraint speech enhancement mask is denoted as M_{S}*, the constraint speech enhancement mask may be expressed as shown in the following equation 18.

$${M}_{S}^{*} = 1 - {M}_{N} \qquad [ Equation 18 ]$$

The speech constraint loss calculation unit 6112 calculates the speech constraint loss indicating the difference between the constraint speech enhancement mask and the ideal speech enhancement mask. In case the speech constraint loss is calculated by a speech constraint loss function L_{S}*, the speech constraint loss function L_{S}* may be expressed as shown in the following Equation 19.

$${L}_{S}^{*} = {M}_{S}^{*} - {M}_{S}^{i} = ( 1 - {M}_{N} ) - {M}_{S}^{i} \qquad [ Equation 19 ]$$

### [6-2-3: Total Loss]

An all loss calculation unit 617 calculates the total loss, which is the sum of the speech enhancement mask loss, the noise enhancement mask loss, the noise constraint loss, and the speech constraint loss (step S62). In case the total loss is calculated by the all loss function L_{ALL}, the all loss function L_{ALL} may be expressed as shown in the following Equation 20.

$${L}_{All} = ( {M}_{N} - {M}_{N}^{i} ) + ( {M}_{S} - {M}_{S}^{i} ) + ( ( 1 - {M}_{S} ) - {M}_{N}^{i} ) + ( ( 1 - {M}_{N} ) - {M}_{S}^{i} ) = ( {M}_{N} + ( 1 - {M}_{S} ) ) + ( {M}_{S} + ( 1 - {M}_{N} ) ) - 2 {M}_{N}^{i} - 2 {M}_{S}^{i} = {M}_{S}^{\sim} + 2 {M}_{N}^{\sim} - 2 {M}_{S}^{i} - 2 {M}_{N}^{i} \qquad [ Equation 20 ]$$

M\tilde{ } can be considered as the estimated value of a mask including the constraint. The sum of the first and second terms of the above equation 20 automatically satisfies M_{S\tilde{ }}+M_{N\tilde{ }}=1, so the same effect as the constraint expressed by equation 5 used in the second embodiment can be acquired. That is, the information processing apparatus 6 according to the sixth embodiment can acquire the same effect as the information processing apparatus 2 according to the second embodiment.

The above equation 20 may be rewritten as the following equation 21. The total loss in the sixth embodiment can be considered to indicate the difference between the estimated value of the mask including the constraint and the ideal value.

$${L}_{All} = 2 ( {M}_{S}^{\sim} - {M}_{S}^{i} ) + 2 ( {M}_{N}^{\sim} - {M}_{N}^{i} ) \qquad [ Equation 21 ]$$

The parameter update unit 212 updates the parameters included in the speech enhancement mask estimation model and the parameters included in the noise enhancement mask estimation model according to the calculation result of the all loss calculation unit 217 (step S27).

### 6-3: Technical Effects of the Information Processing Apparatus 6

The information processing apparatus 6 according to the sixth embodiment does not adopt λ adopted in the second embodiment. Therefore, the information processing apparatus 6 according to the sixth embodiment can reduce the processing load compared to the information processing apparatus 2 according to the second embodiment in that the processing load for determining λ is small.

### 7: Supplementary Note

The following supplementary note is disclosed regarding the embodiments described above.

### Supplementary Note 1

An information processing apparatus including:
a constraint loss calculation unit that calculates a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and
a parameter update unit that updates parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

### Supplementary Note 2

The information processing apparatus according to Supplementary Note 1, further including:
a speech enhancement mask estimation unit that estimates the estimated speech enhancement mask using the speech enhancement mask estimation model;
a noise enhancement mask estimation unit that estimates the estimated noise enhancement mask using the noise enhancement mask estimation model;
a speech enhancement mask loss calculation unit that calculates the speech enhancement mask loss using the estimated speech enhancement mask and the target speech enhancement mask;
a noise enhancement mask loss calculation unit that calculates the noise enhancement mask loss using the estimated noise enhancement mask and the target noise enhancement mask; and
an all loss calculation unit that calculates an all loss acquired by adding the speech enhancement mask loss, the noise enhancement mask loss, and the constraint loss, wherein
the parameter update unit updates the parameters included in the speech enhancement mask estimation model and the parameters included in the noise enhancement mask estimation model in accordance with a calculation result of the all loss calculation unit.

### Supplementary Note 3

The information processing apparatus according to claim 1 or 2, wherein
the constraint loss calculation unit calculates the constraint loss by multiplying the estimated speech emphasis mask and the estimated noise emphasis mask by a volume of the noise-mixed speech.

### Supplementary Note 4

The information processing apparatus according to claim 1 or 2, wherein
the constraint loss calculation unit calculates the constraint loss by raising the estimated speech enhancement mask and the estimated noise enhancement mask to a predetermined exponent.

### Supplementary Note 5

The information processing apparatus according to Supplementary Note 1 or 2, further including
a sound feature extraction unit that extracts noise-mixed speech features from the noise-mixed speech, wherein
the speech enhancement mask estimation model receives the noise-mixed speech features and outputs the estimated speech enhancement mask, and
the noise enhancement mask estimation model receives the noise-mixed speech features and outputs the estimated noise enhancement mask.

### Supplementary Note 6

The information processing apparatus according to Supplementary Note 1 or 2, wherein
the constraint loss calculation unit includes:
   a speech constraint loss calculation unit that calculates a speech constraint loss using the estimated noise emphasis mask and the target speech emphasis mask; and
   a noise constraint loss calculation unit that calculates a noise constraint loss using the estimated speech emphasis mask and the target noise emphasis mask, and
the constraint loss includes the speech constraint loss and the noise constraint loss.

### Supplementary Note 7

An information processing method including:
calculating a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and
updating parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

### Supplementary Note 8

A recording medium on which a computer program is stored, the computer program being configured to allow a computer to execute an information processing method including:
calculating a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and
updating parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

At least some of the configuration elements of each of the above embodiments may be combined with at least some of the other configuration elements of each of the above embodiments as appropriate. Some of the configuration elements of each of the above embodiments may not be used.

This disclosure is not limited to the above embodiments. This disclosure may be changed as appropriate within the scope that does not contradict the technical idea that can be read from the claims and the entire specification. The information processing apparatus, information processing method, and recording medium with such changes are also included in the technical idea of this disclosure. In addition, to the extent permitted by law, all published documents and papers described in this application are incorporated herein.

To the extent permitted by law, this application claims priority based on Japanese Patent Application No. 2023-039058 filed on Mar. 13, 2023, and incorporates all of its disclosure herein.

### DESCRIPTION OF REFERENCE CODES

1, 2, 3, 4, 5, 6 information processing apparatus
11, 211, 311, 411, 611 constraint loss calculation unit
12, 212, 512 parameter update unit
211 parameter storage unit
222, 522 training information storage unit
213, 513 speech enhancement mask estimation unit
214, 514 noise enhancement mask estimation unit
215, 515 speech enhancement mask loss calculation unit
216, 516 noise enhancement mask loss calculation unit
217, 617 all loss calculation unit
218, 518 noise-mixed speech input unit
519 sound feature extraction unit
6111 noise constraint loss calculation unit
6112 speech constraint loss calculation unit

What is claimed is:

1. An information processing apparatus comprising:
at least one memory storing instructions; and
at least one processor that is configured to execute the instructions to:
calculate a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and
update parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

2. The information processing apparatus according to claim 1, wherein the at least one processor that is configured to execute the instructions to:
estimate the estimated speech enhancement mask using the speech enhancement mask estimation model;
estimate the estimated noise enhancement mask using the noise enhancement mask estimation model;
calculate the speech enhancement mask loss using the estimated speech enhancement mask and the target speech enhancement mask;
calculate the noise enhancement mask loss using the estimated noise enhancement mask and the target noise enhancement mask;
calculate an all loss acquired by adding the speech enhancement mask loss, the noise enhancement mask loss, and the constraint loss; and,
update the parameters included in the speech enhancement mask estimation model and the parameters included in the noise enhancement mask estimation model in accordance with a calculation result of the all loss.

3. The information processing apparatus according to claim 1, wherein the at least one processor that is configured to execute the instructions to
calculate the constraint loss by multiplying the estimated speech emphasis mask and the estimated noise emphasis mask by a magnitude of the noise-mixed speech.

4. The information processing apparatus according to claim 1, wherein the at least one processor that is configured to execute the instructions to
calculate the constraint loss by raising the estimated speech enhancement mask and the estimated noise enhancement mask to a predetermined exponent.

5. The information processing apparatus according to claim 1, wherein the at least one processor that is configured to execute the instructions to
extract noise-mixed speech features from the noise-mixed speech, wherein
the speech enhancement mask estimation model receives the noise-mixed speech features and outputs the estimated speech enhancement mask, and
the noise enhancement mask estimation model receives the noise-mixed speech features and outputs the estimated noise enhancement mask.

6. The information processing apparatus according to claim 1, wherein the at least one processor that is configured to execute the instructions to:
calculate a speech constraint loss using the estimated noise emphasis mask and the target speech emphasis mask; and
calculate a noise constraint loss using the estimated speech emphasis mask and the target noise emphasis mask, and
the constraint loss includes the speech constraint loss and the noise constraint loss.

7. An information processing method comprising:
calculating a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and
updating parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.

8. A non-transitory recording medium on which a computer program is stored, the computer program being configured to allow a computer to execute an information processing method comprising:
calculating a constraint loss using an estimated speech enhancement mask output by a speech enhancement mask estimation model in case a noise-mixed speech is input, and an estimated noise enhancement mask output by a noise enhancement mask estimation model in case the noise-mixed speech is input; and
updating parameters included in the speech enhancement mask estimation model and parameters included in the noise enhancement mask estimation model, using a speech enhancement mask loss indicating a difference between the estimated speech enhancement mask and a target speech enhancement mask calculated in case a speech and a noise in the noise-mixed speech are known, and a noise enhancement mask loss indicating a difference between the estimated noise enhancement mask and a target noise enhancement mask calculated in case a speech and a noise in the noise-mixed speech are known, and the constraint loss.
